(19) United States
(12) Patent Application Publication
(10) Pub. No.: US 2010/0315333 A1
(43) Pub. Date: Dec. 16, 2010

(54) Integrated Wired/Wireless Virtual Unit Control Apparatus

(75) Inventor: Wei HSU, Taipei County (TW)

Correspondence Address: Chih Feng Yeh, 188 Old Castle Point Rd., Wappingers Falls, NY, 12590-7069, US

(73) Assignee: WEISTECH TECHNOLOGY CO., LTD., Chung Ho City (TW)

(21) Appl. No.: 12/794,810

(22) Filed: Jun. 7, 2010

(30) Foreign Application Priority Data
Jun. 10, 2009 (TW) 98119414
Dec. 9, 2009 (TW) 98142131

(51) Int. Cl. G06F 3/033; G06F 1/00

(52) U.S. Cl. 345/157; 713/300

(57) ABSTRACT

The present invention discloses an integrated wired/wireless virtual unit control apparatus comprising a MCU; a wired transmission module, to connect to the appliances and to receive the energies under wired conditions; a battery set, to receive and to store the energies from the interface; a finger control signal module, to provide the button signal instead of the motion of the virtual unit control apparatus; a wireless transmission module, to transmit the signal to the appliances under wireless conditions; and an appliance switching module, to switch the different appliances and their operating systems to be controlled. The integrated wire/wireless virtual unit control apparatus can be charged via wire, operated under wired/wireless conditions, and integrated with multiple operating modes. The integrated wired/wireless virtual unit control apparatus can be held and used by one hand and it can copy the codes of function keys from a television remote controller. In some embodiments, the integrated wired/wireless virtual unit control apparatus comprises a display for displaying the information.

### CROSS-REFERENCE TO RELATED APPLICATIONS

The present application is based on, and claims priority from, Taiwan Application Serial Number 98119414, filed Jun. 10, 2009, and Taiwan Application Serial Number 98142131, filed Dec. 9, 2009, the disclosure of both Taiwan Applications are hereby incorporated by reference herein in its' entirety.

### TECHNICAL FIELD

The present invention is generally related to the field of wireless virtual unit control apparatus and, more particularly, to an integrated wired/wireless virtual unit control apparatus including multiple controlling modes.

### RELATED ART

With the development of technology, daily used digital (or some mobile devices) including not only personal computers (PCs) and notebooks but also a plurality of other mobile devices such as netbooks (or UMPCs), mobile phones, electronic dictionaries, personal digital assistants (PDAs), global positioning systems (GPSs), digital mobile audio devices, mobile gaming devices, etc. Most of the above devices are able to be connected to the internet via wireless fidelity (WiFi), wideband code division multiple access (WCDMA, or 3G), high-speed downlink packet access (HSDPA, or 3.5G), etc. The devices can also access to the internet via broad band network by the wireless access points (APs) set in a household environment for providing functions of surfing the web, checking the web maps, using instant messaging services, etc. In addition, the above devices own mobility and provide additional functions such as playing games, listening music, checking electronic dictionaries, taking pictures and videos, etc. However, the mobile devices are often limited to have a relative smaller display screen and less choice of inputting ways by the restriction of their relative smaller size and weight. Conventionally, pushing buttons is the most general way for users to input data into the mobile devices, but the number of button are often insufficient for meeting the corresponding number of functions provided by the mobile devices. Though touch panel display, being popular recently, is able to provide a plurality of virtual keys and thus to increase diversity and convenience of inputting ways, the poor accuracy provided by the touch panel display is not generally been accepted. Especially when it is applied to an appliance having small-sized display, the events of touching the wrong positions (touching mistakenly) by the user are always happened with touch panel display. Handling the touch panel display correctly is getting even tougher when the user is walking or taking vehicles. Consequently, it should soon be popular to make each of the mobile devices have a cursor and control the cursor by a mouse device. The United State Patent Publication 2006/0019706 provides a mobile phone with a mouse device for improving the degree of convenience for controlling the mobile phone. However, the mouse device is attached to the mobile phone, and thus the controlling interface is not as convenient as a general wireless mouse. Further, the above mouse device can not be shared with other digital devices for convenience.

Hence, if the conventional wireless mouse for a PC can be modified and applied to the above digital devices, the plurality of digital devices can be controlled in turn by only one single mouse for saving additional costs and ease of carrying other mouse devices. Thus, controlling the digital devices can be as convenient as controlling a PC by a wireless mouse.

However, the sensor of a conventional wire or wireless mouse is often implemented as a ball module, an optical module, or a laser module, and each of them is required to be operated upon a supporting surface such as a mouse pad or a desktop. When the surface is not acquirable such as the mouse is in the air, the above-mentioned mouse should not be operated effectively. Therefore, it is needed to have a modified wireless mouse being able to be operated both upon the surface and in the air while accurately controlling the plurality of digital devices. The U.S. Pat. No. 5,506,605 provides a mouse that can be manipulated in the air for controlling the cursor in the screen by moving the wrist or the arm of the user. However, the mouse is not well suited to the conditions operated with small-sized mobile digital devices, because small-sized mobile digital devices are often used in the environment with insufficient room for freely moving the wrist or the arm of the user. So the controlling mode requiring large physical movements is not such proper for the above-mentioned situation. Further, dealing with smaller devices or manipulating with higher requirement of accuracy seems to have more shortcomings for the solution of touch panel screen.

Furthermore, in consideration of the consumption of electric power, the United State Patent Publication 2006/0232555 provides a wired/wireless mouse that can be connected and charged by USB or PS/2 interface. However, the wired/wireless mouse does not provide a solution to solve the problems and shortcomings mentioned above.

Therefore, it is needed to have an integrated wired/wireless mouse including the advantages of the prior arts and adding new elements for mending the inconvenience on manipulation. The user can use the mouse without existing of any supporting surfaces and manipulate with any kind of postures for avoiding discomfort caused by maintaining a stationary posture while manipulating and lowering the difficulty of manipulation.

### SUMMARY

The embodiments of the present invention provide an integrated wired/wireless virtual unit control apparatus.

In a first aspect of the embodiments of the present invention, an integrated wired/wireless virtual unit control apparatus is provided. The integrated wired/wireless virtual unit control apparatus comprises at least one wired connecting interface such as USB or PS/2 to be connected to at least one appliance. When connected, the integrated wired/wireless virtual unit control apparatus is supplied with electric power, the battery set is charged, and the control signals are transmitted.

In another aspect of the embodiments of the present invention, an integrated wired/wireless virtual unit control apparatus is provided. The integrated wired/wireless virtual unit control apparatus comprises at least one wireless transmission module, to supply power by the battery set and transmit control signals under wireless conditions.

In another aspect of the embodiments of the present invention, an integrated wired/wireless virtual unit control apparatus is provided. The integrated wired/wireless virtual unit control apparatus comprises at least one gyro module, to generate movement signals according to user's movement in the air and to control the appliance according to the movement signals for providing a way of control upon intuition.

In another aspect of the embodiments of the present invention, an integrated wired/wireless virtual unit control apparatus is provided. The integrated wired/wireless virtual unit control apparatus comprises at least one finger control module, to generate movement signals according to movements of user's finger and to control the appliance according to the movement signals for providing a way of control with relative higher sensitivity and stability. The finger control module provides a way of control not being necessary to place on a supporting surface and to sway with big movement, and thus it is a preferred solution for people with, for example, disabilities.

In another aspect of the embodiments, an integrated wired/wireless virtual unit control apparatus is provided. The integrated wired/wireless virtual unit control apparatus comprises at least one signal selection module for selecting one of the above-mentioned movement signals to control the appliance. The integration of different control mode provides the user freedom to select a most suitable control mode according to the environment at the time.

In another aspect of the embodiments of the present invention, an integrated wired/wireless virtual unit control apparatus is provided. The integrated wired/wireless virtual unit control apparatus comprises at least one appliance switching module, to switch the different appliances and their operating systems to be controlled. The appliances include digital devices which can be controlled by a mouse, such as personal computers (PCs), notebooks, netbooks (or UMPCs), mobile phones, electronic dictionaries, personal digital assistants (PDAs), global positioning systems (GPSs), digital mobile audio devices, mobile gaming devices, etc. Accordingly, the integrated wired/wireless virtual unit control apparatus can switch among the different appliances and their different operating systems.

In another aspect of the embodiments of the present invention, an integrated wired/wireless virtual unit control apparatus is provided. The integrated wired/wireless virtual unit control apparatus comprises at least one auto-detecting module for automatically detecting the appliances matching the codes of the integrated wired/wireless virtual unit control apparatus or the appliances compatible with the control of the integrated wired/wireless virtual unit control apparatus.

In another aspect of the embodiments of the present invention, an integrated wired/wireless virtual unit control apparatus is provided. The integrated wired/wireless virtual unit control apparatus comprises at least one television remote controller chip and one infra-red emission module, to have the function of copying essential controller keys such as channel selecting, volume adjusting, power turning on/off, etc., and it becomes a mobile backup television remote controller.

In another aspect of the embodiments of the present invention, an integrated wired/wireless virtual unit control apparatus is provided. The integrated wired/wireless virtual unit control apparatus comprises at least one display screen such as liquid-crystal display (LCD) screen for displaying related information of the operation of the integrated wired/wireless virtual unit control apparatus.

In another aspect of the embodiments of the present invention, a method of using an integrated wired/wireless virtual unit control apparatus is provided. The method provides functions of changing the default speed of movement of virtual articles on application devices, to fit the needs when users using the integrated wired/wireless virtual unit control apparatus.

The aspects and features of the present invention are detailed in the following description of the embodiments and the accompanying figures for providing thoroughly understanding of the present invention.

### BRIEF DESCRIPTION OF THE DRAWINGS

FIG. 1 illustrates the functional block diagram of the integrated wired/wireless virtual unit control apparatus according to the preferred embodiments of the present invention.

FIGS. 2, and 2A illustrates another functional block diagram of the integrated wired/wireless virtual unit control apparatus according to the preferred embodiments of the present invention.

FIGS. 3A, 3B, and 3C illustrates the perspective diagrams of the integrated wired/wireless virtual unit control apparatus according to the preferred embodiments of the present invention.

FIG. 4 illustrates another perspective diagrams of the integrated wired/wireless virtual unit control apparatus according to the preferred embodiments of the present invention.

FIGS. 5A, 5B, and 5C illustrates the perspective diagrams of the integrated wired/wireless virtual unit control apparatus according to the preferred embodiments of the present invention.

### DETAILED DESCRIPTION

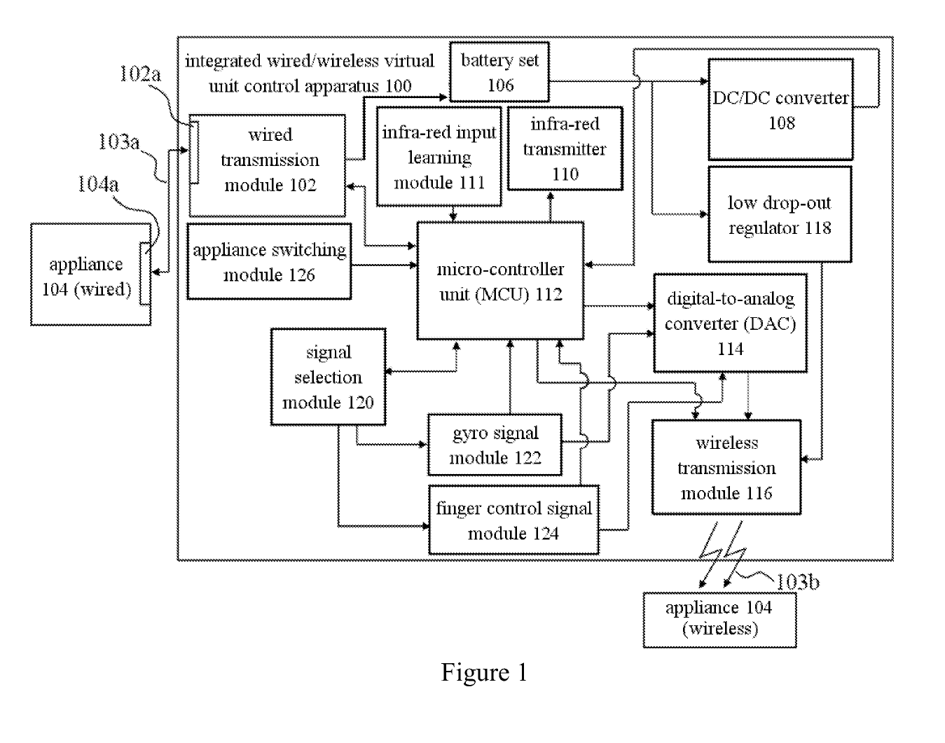

FIG. 1 illustrates the functional block diagram of the integrated wired/wireless mouse according to the embodiments of the present invention. The skilled in the art should appreciate that detailed components may not be showed in the figure for purpose of brevity. In FIG. 1, the integrated wired/wireless mouse 100 comprises a wired transmission module 102 comprising connecting interface 102a such as USB or PS/2. The integrated wired/wireless mouse 100 can be connected to the corresponding wired interface 104a of an appliance 104 such as a PC for transmitting both electric power and control signals via a USB or PS/2 cable 103a. The integrated wired/wireless mouse also comprises a battery set 106 coupling to the wired transmission module 102, to receive and store the electric power from the wired transmission module 102; a five voltage DC/DC converter 108 coupling to the battery set 106, to receive the electric power from the battery set 106 and transfer the electric power into a predetermined amplitude; a micro-controller unit (MCU) 112 coupling to the five volt DC/DC converter 108 and wired transmission module 102, to receive the direct current from the five volt DC/DC converter 108 and the electric power/control signals from wired transmission module 102. Wherein the five volt is for purpose of exemplifying but not for limiting, and the voltage values can be adjusted for various conditions. Further, the MCU 112 comprises the software and firmware needed for maintaining the operation of the integrated wired/wireless mouse 100. The MCU 112 receives the electric power from the five volt DC/DC converter 108 for operating, transfers the movement signal into control signal, provides the control signals to appliance 104 via wire transmission module 102, and controls the appliance 104. Accordingly, when the wired transmission module 102 is connected to a USB or PS/2 cable 103a, the transmission is carried out via USB or PS/2.

In the embodiments of the present invention, the MCU 112 captures control signals from a user and thus controls the operation of the integrated wired/wireless mouse. The MCU 112 also provides the function of power management such as automatically turning on/off on predetermined time. Further, the integrated wired/wireless mouse 100 also comprises a digital-to-analog converter (DAC) 114 coupling to the MCU 112, to receive the signal from the MCU 112 and transfer the signal into a managed signal; a wireless transmission module 116, such as Bluetooth wireless transmission module, coupling to DAC 114, to receive the managed signal from DAC 114, wirelessly transmit with appliance 104, and wirelessly control the appliance 104; a low drop-out regulator (LDO regulator) 118 coupling to the battery set 106, to receive the electric power from the battery set 106, execute LDO regulation, and provide the electric power after LDO regulation to wireless transmission module 116. Accordingly, when the wired transmission module 102 is not connected with a USB or PS/2 cable 103a, the wireless transmission module 116 is taking it over to proceed signal transmission and to control the appliance. It should be noted that when transmitting wirelessly, it should exist an internal or external corresponding wireless transmitting controller (not illustrated) coupling to the control unit (not illustrated) of the appliance 104 for transmitting wireless control signal 103b between the wireless transmission module 116 of the integrated wired/wireless mouse 100. It should also be noted that the wireless transmission module 116 is not limited to Bluetooth wireless transmission module in the embodiments of the present invention. In other embodiments of the present invention, the wireless transmission module 116 further comprises infra-red, radio frequency (RF), Zigbee, or other wireless transmission modules. The corresponding wireless controller of the appliance also comprises infra-red, radio frequency (RF), Zigbee, or other wireless transmitters. Further, the above-mentioned DAC may be replaced to analog-to-digital converter (ADC), or a combination thereof when dealing with different signals.

In the embodiments of the present invention, the integrated wired/wireless mouse 100 further comprises left key, right key, roller key, function key, etc. They coupling to the MCU 112 for providing functions of clicking, double-clicking, turning page, pressing and dragging, setting and using function key, etc.

In the embodiments of the present invention, the integrated wired/wireless mouse 100 further comprises a signal selection module 120 coupling to the MCU 112; a gyro (or gyroscopic) signal module 122 coupling to signal selection module 120 and the MCU 112. When signal selection module 120 is selected to use gyro signal module 122, the movement signals of the integrated wired/wireless mouse 100 caused by moving the mouse in the air can be provided to the MCU 112, and then it is transmitted to appliance 104 via DAC 114 and wireless transmission module 116. The gyro signal module 122 is utilized as a motion sensor comprising acceleration and direction sensors for detecting the movement signals of the mouse in the air. The gyro signal module 122 may comprises digital output from tri-axial acceleration sensors and the related circuit coupling to the MCU 112 for detecting the amplitude of acceleration along the orthogonal axes and transferring it to the MCU 112. In general, the movements, vibrations, inclinations or other motions of the integrated wired/wireless mouse 100 caused by the user can thus be detected.

In the embodiments of the present invention, the integrated wired/wireless mouse 100 further comprises a finger control signal module 124 coupling to the signal selection module 120 and the MCU 112. When the signal selection module 120 selects to use the finger control signal module 124, the movement signal generated by the finger control signal module 124 can thus be provided to the MCU 112, and then it is transmitted to appliance 104 via DAC 114 and wireless transmission module 116. The finger control signal module 124 may comprise directional pad (D-Pad), joystick, tracking ball, touch panel, keyboard, etc. For example, controlling the movement of the cursor in the PC by the above-mentioned D-pad, the control signal is generated by the finger of the user, and it is not required for moving the mouse on a supporting surface or waving the mouse in the air. Further, the sensitivity and stability of the D-pad is relative higher than the gyro signal module, and therefore it is preferred to use D-pad by the user in some specific conditions with relative high requirement of sensitivity and stability. In some embodiments of the present invention, when the finger control signal module 124 is implemented as D-pad, the integrated wired/wireless mouse 100 further comprises at least one joystick potentiometer coupling to the MCU 112. When the user sways the joystick, the at least one joystick potentiometer may output two sets of voltage values, for example, along x and y axes to the MCU 112. The MCU 112 reads the sets of voltage values via a ADC, determines the position of the joystick, and then accomplishes the purpose of moving and positioning the cursor.

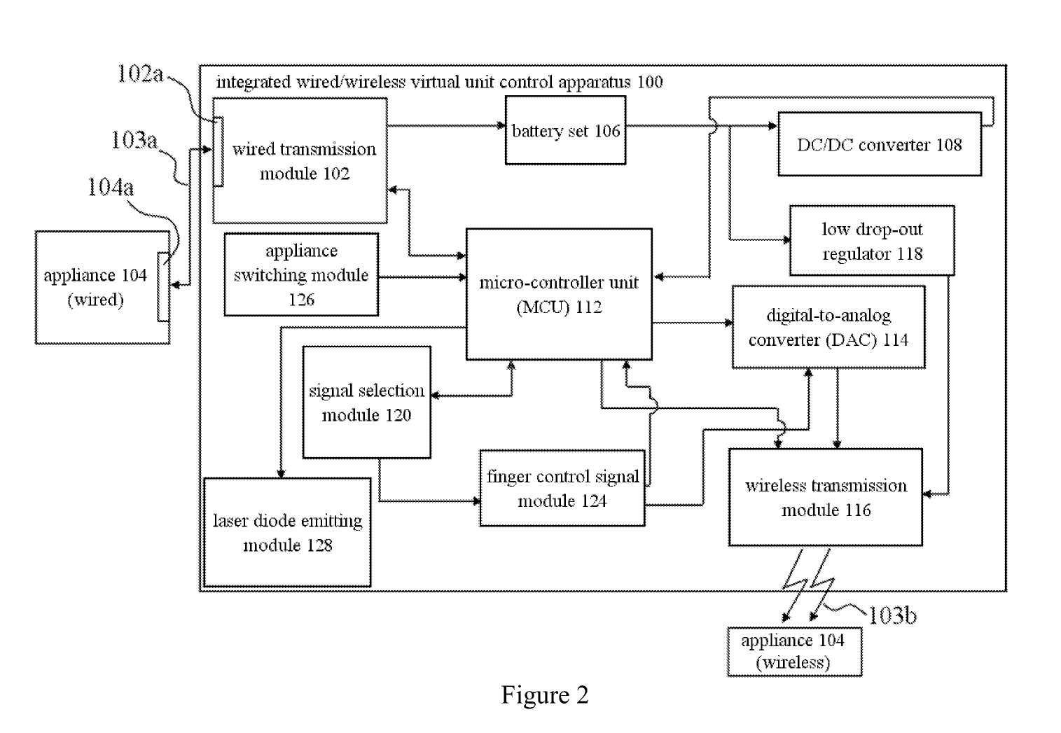

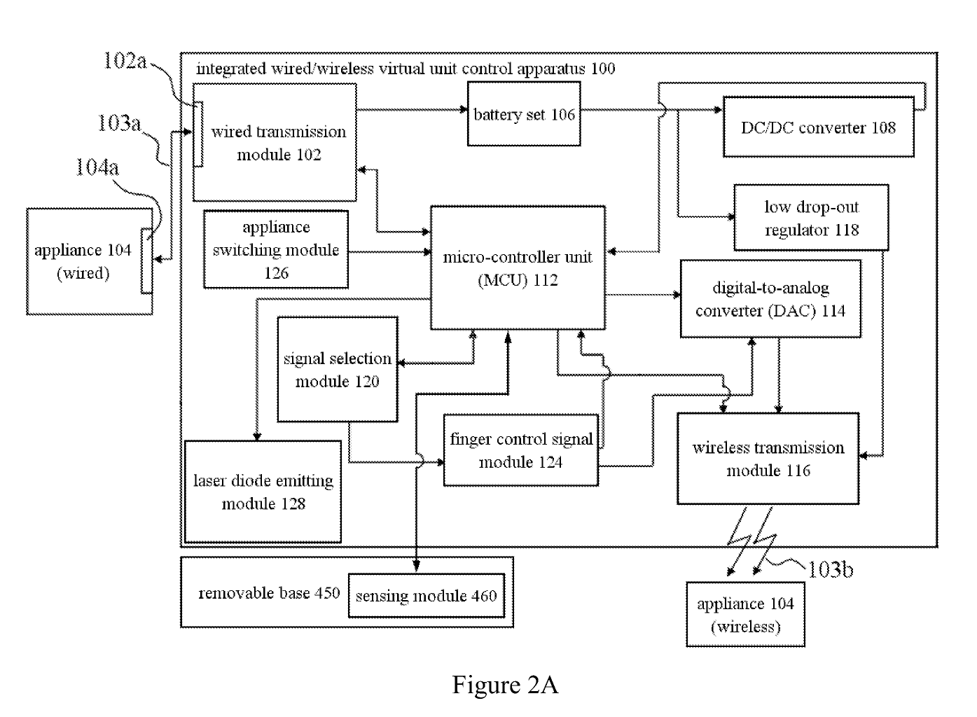

FIG. 2 illustrates another functional block diagram of the integrated wired/wireless virtual unit control apparatus according to the embodiments of the present invention. The skilled in the art should appreciate that detailed components may not be showed in the figure for purpose of brevity. In FIG. 2, the integrated wired/wireless virtual unit control apparatus 100 comprises a wired transmission module 102 comprising connecting interface 102a such as USB or PS/2. The integrated wired/wireless virtual unit control apparatus 100 can be connected to the corresponding wired interface 104a of an appliance 104 such as a PC for transmitting both electric power and control signals via a USB or PS/2 cable 103a. The integrated wired/wireless virtual unit control apparatus also comprises a battery set 106 coupling to the wired transmission module 102, to receive and store the electric power from the wired transmission module 102; a five voltage DC/DC converter 108 coupling to the battery set 106, to receive the electric power from the battery set 106 and transfer the electric power into a predetermined amplitude; a micro-controller unit (MCU) 112 coupling to the five volt DC/DC converter 108 and wired transmission module 102, to receive the direct current from the five volt DC/DC converter 108 and the electric power/control signals from wired transmission module 102. Wherein the five volt is for purpose of exemplifying but not for limiting, and the voltage values can be adjusted for various conditions. Further, the MCU 112 comprises the software and firmware needed for maintaining the operation of the integrated wired/wireless virtual unit control apparatus 100. The MCU 112 receives the electric power from the five volt DC/DC converter 108 for operating, transfers the movement signal into control signal, provides the control signals to appliance 104 via wire transmission module 102, and controls the appliance 104. Accordingly, when the wired transmission module 102 is connected to a USB or PS/2 cable 103a, the transmission is carried out via USB or PS/2.

In the embodiments of the present invention, the MCU 112 captures control signals from a user and thus controls the operation of the integrated wired/wireless virtual unit control apparatus 100. The MCU 112 also provides the function of power management such as automatically turning on/off on predetermined time. Further, the integrated wired/wireless virtual unit control apparatus 100 also comprises a digital-to-analog converter (DAC) 114 coupling to the MCU 112, to receive the signal from the MCU 112 and transfer the signal into a managed signal; a wireless transmission module 116, such as Bluetooth wireless transmission module, coupling to DAC 114, to receive the managed signal from DAC 114, wirelessly transmit with appliance 104, and wirelessly control the appliance 104; a low drop-out regulator (LDO regulator) 118 coupling to the battery set 106, to receive the electric power from the battery set 106, execute LDO regulation, and provide the electric power after LDO regulation to wireless transmission module 116. Accordingly, when the wired transmission module 102 is not connected with a USB or PS/2 cable 103a, the wireless transmission module 116 is taking it over to proceed signal transmission and control the appliance. It should be noted that when transmitting wirelessly, it should exist an internal or external corresponding wireless transmitting controller (not illustrated) coupling to the control unit (not illustrated) of the appliance 104 for transmitting wireless control signal 103b between the wireless transmission module 116 of the integrated wired/wireless virtual unit control apparatus 100. It should also be noted that the wireless transmission module 116 is not limited to Bluetooth wireless transmission module in the embodiments of the present invention. In other embodiments of the present invention, the wireless transmission module 116 further comprises infra-red, radio frequency (RF), Zigbee, or other wireless transmission modules. The corresponding wireless controller of the appliance also comprises infra-red, radio frequency (RF), Zigbee, or other wireless transmitters. Further, the above-mentioned DAC may be replaced to analog-to-digital converter (ADC), or a combination thereof when dealing with different signals.

In the embodiments of the present invention, the integrated wired/wireless virtual unit control apparatus 100 further comprises left key, right key, roller key, function key, etc. They coupling to the MCU 112 for providing functions of clicking, double-clicking, turning page, pressing and dragging, setting and using function key, etc.

In the embodiments of the present invention, the integrated wired/wireless virtual unit control apparatus 100 further comprises a finger control signal module 124 coupling to the signal selection module 120 and the MCU 112. When the signal selection module 120 selects to use the finger control signal module 124, the movement signal generated by the finger control signal module 124 can thus be provided to the MCU 112, and then it is transmitted to appliance 104 via DAC 114 and wireless transmission module 116. The finger control signal module 124 may comprise directional pad (D-Pad), joystick, tracking ball, touch panel, keyboard, etc. For example, controlling the movement of the cursor in the PC by the above-mentioned D-pad, the control signal is generated by the finger of the user, and it is not required for moving the virtual unit control apparatus 100 on a supporting surface or waving the virtual unit control apparatus 100 in the air. Further, the sensitivity and stability of the D-pad is relative higher than the gyro signal module, and therefore it is preferred to use D-pad by the user in specific conditions with relative high requirement of sensitivity and stability. In some embodiments of the present invention, when the finger control signal module 124 is implemented as D-pad, the integrated wired/wireless virtual unit control apparatus 100 further comprises at least one joystick potentiometer coupling to the MCU 112. When the user sways the joystick, the at least one joystick potentiometer may output two sets of voltage values, for example, along x and y axes to the MCU 112. The MCU 112 reads the sets of voltage values via a ADC, determines the position of the joystick, and then accomplishes the purpose of moving and positioning the cursor.

In the embodiments of the present invention, the integrated wired/wireless virtual unit control apparatus 100 further comprises a laser diode emitting device 128 coupling to the MCU 112. When turning on the laser diode emitting device 128, it projects a light spot, provides functions of a pointer.

In the embodiments of the present invention, the integrated wired/wireless virtual unit control apparatus 100 further comprises a cursor movement speed controlling function. When the finger control signal module 124 is implemented as joystick cooperate with buttons, it is able to use the joystick alone to control the movement and the position of the cursor, and the speed of movement of the cursor is the default speed; also, it is able to press the default first button (not shown) and use the joystick to control the movement and the position of the cursor simultaneously, then the speed of movement of the cursor descends; further, it is able to press the default second button (not shown) and use the joystick to control the movement and the position of the cursor simultaneously, then the speed of movement of the cursor increases. User can adjust the speed of movement of the cursor freely, to fit different users, software, using conditions, using habits and/or so on.

Further, in some embodiments of the present invention, the integrated wired/wireless virtual unit control apparatus 100 further comprises at least one auto-detecting module (not illustrated) coupling to the MCU 112 for automatically detecting the appliances matching the codes of the integrated wired/wireless virtual unit control apparatus 100 or the appliances compatible with the control of the integrated wired/wireless virtual unit control apparatus 100. The integrated wired/wireless virtual unit control apparatus 100 further comprises a reset switch (not illustrated) coupling to the MCU 112 for resetting the connecting and data transmitting between the integrated wired/wireless virtual unit control apparatus 100 and the appliance 104, or set the continued press time of some buttons in the finger control signal module 124. By facilitating of auto-detecting module and the reset switch, the convenience and practicability of signal matching and re-matching between the integrated wired/wireless virtual unit control apparatus 100 and the appliance 104 is greatly enhanced.

Upon the implementation of gyro signal module 122 and/or finger control signal module 124 in the embodiments of the present invention, another function is provided for the user as having ability of handwriting letters or symbols in the air. Some handwriting recognition software is required to install into the appliance 104. The software can be, for example, “Graffiti”, which is a software based on “Palm OS”. The reference information is as “http://en.wikipedia.org/wiki/Graffiti (Palm OS)”. Thus, by making continuous strokes, the user could write one or more letters in the air. However, it should be noted that “Graffiti” is just as an example but not a limitation. Other software can also be adopted in other embodiments of the present invention. In the further embodiments of the present invention, the letters are not limited to English or numbers, and other letters such as Chinese, letters of other languages, symbols, etc., are also feasible. The different letters can be related to predetermined gestures or the combinations of the existed gestures from the “Graffiti”. Furthermore, due to the unavoidable mistakes of recognition in handwriting inputs, a function key is designated to clean the mistakes immediately to facilitate functions of fast deleting and re-inputting and improve the practicability of the present invention.

Moreover, in other embodiments of the present invention, the integrated wired/wireless virtual unit control apparatus 100 comprises the function of copying the essential television remote controller keys such as channel selecting, volume adjusting, power turning on/off, etc. Thus, the wired/wireless virtual unit control apparatus 100 provides a mobile backup television remote controller. The function can be implemented as the combination of a television remote controller chip, wireless transmission module 116, and the corresponding circuit, wherein the chip can be implemented as an independent chip coupling to the MCU 112 or a chip integrated with MCU 112. However, in the embodiments, they are integrated within one chip. Further, the integrated wired/wireless virtual unit control apparatus 100 comprises an infra-red transmitter 110 coupling to the MCU 112 for providing the function of a television remote controller; and an infra-red input learning module 111 coupling to the MCU 112 for providing the function of learning the essential keys and matching with a television receiver. The infra-red transmitter 110 can be implemented as an independent component or an integrated component with the wireless transmission module 116, and they are illustrated as independent components in FIG. 1.

In further embodiments of the present invention, the integrated wired/wireless virtual unit control apparatus 100 further comprises a function module containing a memory chip for storing the instructions maintaining the operation of the integrated wired/wireless virtual unit control apparatus 100. However, the function module can be implemented as an independent chip or an integrated chip with the MCU 112, television remote controller chip, etc.

In the embodiments of the present invention, the appliance 104 comprises personal computers (PCs), notebooks, netbooks (or UMPCs), mobile phones, electronic dictionaries, personal digital assistants (PDAs), global positioning systems (GPSs), digital mobile audio devices, mobile gaming devices or the combinations thereof.

In one embodiment of the present invention, the appliance 104 further comprises at least one appliance switching module 126, couples to the MCU 112, for switching between several hardware, operation system, or the combination thereof of the appliance 104.

It should be appropriate in the detailed description of the embodiments of the present invention, the variety functions are provided with modules such as gyro signal module, finger control signal module, etc. However, an integrated chip containing the above-mentioned functions can provide the same functions as well. Therefore, the functions provided thereof can be implemented as independent chips coupling to an MCU, or they can be integrated as a single chip with the same ability.

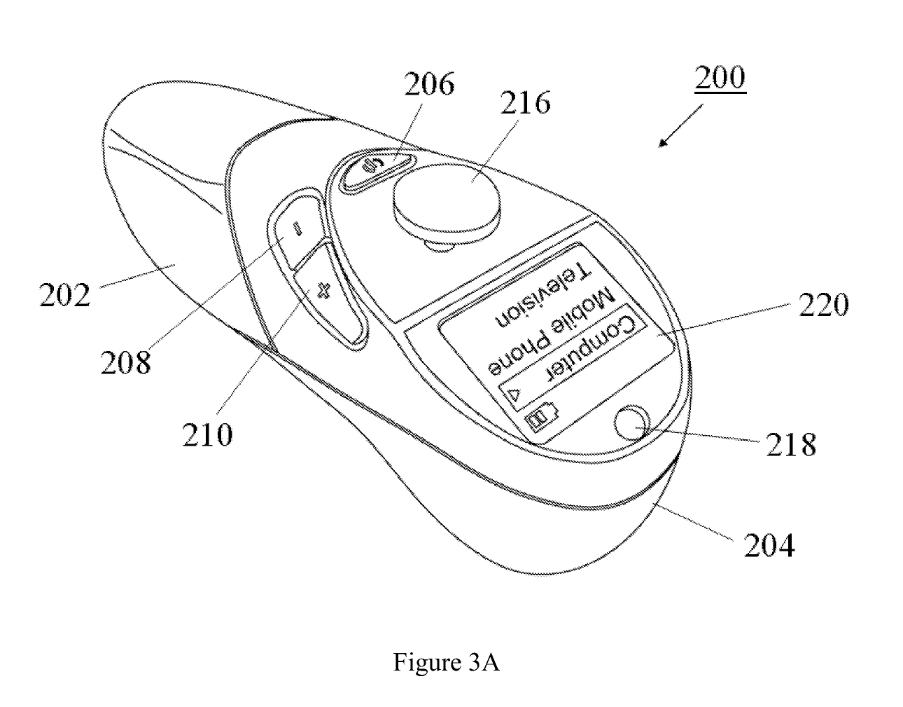

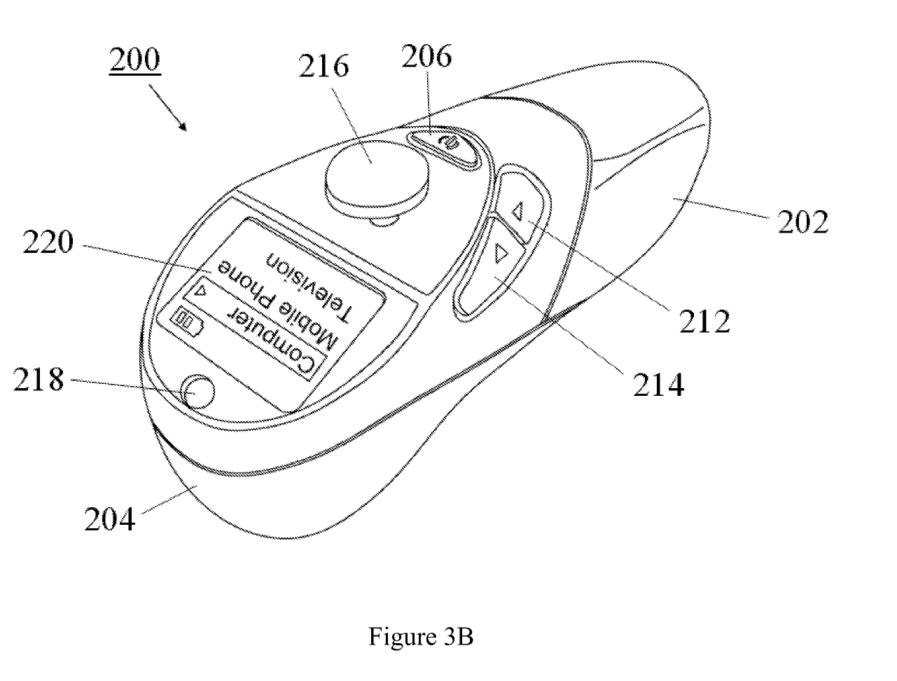

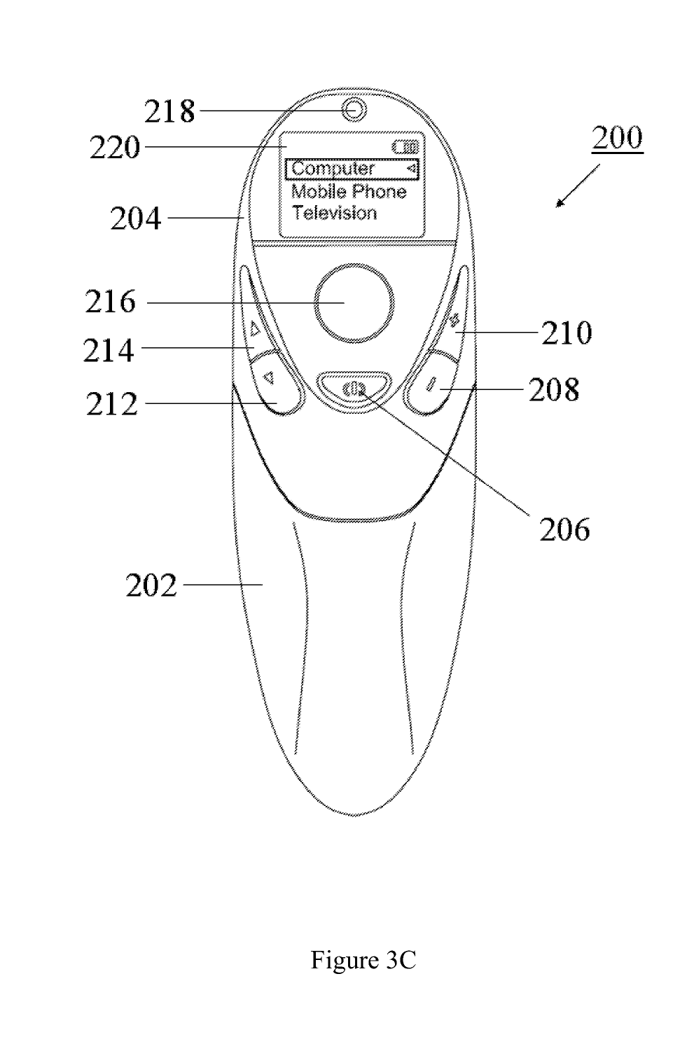

FIGS. 3A, 3B, and 3C illustrate the perspective diagrams of the integrated wired/wireless virtual unit control apparatus according to the embodiments of the present invention. The housing of the integrated wired/wireless virtual unit control apparatus 200 essentially comprises a grip portion 202 and a main portion 204, and they can be formed as an integrated component or as combinative components. The integrated wired/wireless virtual unit control apparatus 200 comprises a plurality of control keys formed on the surface of its upper half. The plurality of operational components comprise a power key 206, to provide function of turning on/off the power of the virtual unit control apparatus 200; a first key 208, a second key 210, a third key 212, and a forth key 214 formed around the power key 206 for providing different functions. It should be noted that for purpose of brevity, it only shows four key 208, 210, 212, and 214 in illustrations. However, any other number of keys may be formed in a similar way to provide more variation in other embodiments of the present invention. The first key 208 and the second key 210 can be implemented as, for example, volume decrease and increase buttons, separately. They can be implemented as the zoom in/out controlling key of viewing pictures as well. The third key 212 and forth key 214 can be implemented as, for example, direction control key, for controlling the direction of, for example, cursor, visual angle, etc. Each of the keys mentioned above is coupled to the MCU 112 and the related component in FIG. 1 for providing the above-mentioned functionalities. Further, the integrated wired/wireless mouse 200 comprises a D-pad, a joystick, a tracking ball, a touch panel, a keyboard, of the combinations thereof for inputting control signal by the user. However, it is implemented as a joystick in FIGS. 3A, B, and C.

In FIGS. 3A, B, and C, the integrated wired/wireless virtual unit control apparatus 200 further comprises a signal light 218 and a display screen 220. The signal light 218 can be implemented as a light-Emitting Diode (LED) coupling to the MCU 112 for providing reminder functions. For example, the signal light 218 can be cooperated with the infra-red transmit 110 illustrated in FIG. 1. When the user controls the television via the infra-red transmit 110, the signal light 218 may emitting light with the corresponding signal transmission and remind the user the condition under processing. Further, the signal light 218 can also be cooperated with other signal modules, such as gyro signal module 122, finger control signal module 124, and other modules or components mentioned above. When cooperating with various signals, the signal light 218 may emit different colors for better discrimination. The display screen 220 can be implemented as a liquid crystal display (LCD), but it is not limited to LCD. The display screen 220 may be implemented as any other thin display as well, and it provides the information to the user. For example, it illustrates the battery icon, the selection index, and several selection items such as “Computer”, “Mobile Phone”, and “Television”. Wherein the battery icon provides the information of the remaining electric power of the integrated wired/wireless virtual unit control apparatus 200, and thus the user can be reminded for charging the mouse. The illustrated “Computer” shows that the user uses the integrated wired/wireless virtual unit control apparatus 200 to control a PC. The display screen 220 may be switched to different pages for display information related to all the functions the integrated wired/wireless virtual unit control apparatus 200 can provide in a limited layout, and then the user can check and choose items on it. In the embodiments of the present invention, the housing and the control keys of the integrated wired/wireless virtual unit control apparatus 200 are designed for ease of, for example, moving the cursor, gaming games, or controlling the television by the user. However, in other embodiments, the design may be changed for optimization for certain purpose. For example, several keys designated as “MJ”, “A”, “B”, “C”, “D” can be formed on the housing of the integrated wired/wireless virtual unit control apparatus 200 and each of them is coupled to the MCU 112 and the related components in FIG. 1. Wherein, “MJ” may be a D-pad, joystick, tracking ball, touch panel, keyboard, etc., and it is coupled to the finger control signal module 124 illustrated in FIG. 1 for controlling the integrated wired/wireless virtual unit control apparatus 200 by the moving of fingers of the user. “A”, “B”, “C”, and “D” may be function keys. Different functions can be designated to the function keys by the user. The “E”, “F” or other function keys may also implemented on demand for fully making use of the present invention.

Further, the combinations of above-mentioned keys may be utilized as smart keys. For example, the function of closing present window may be provided by the smart key, as the “Alt+F4” in a conventional keyboard.

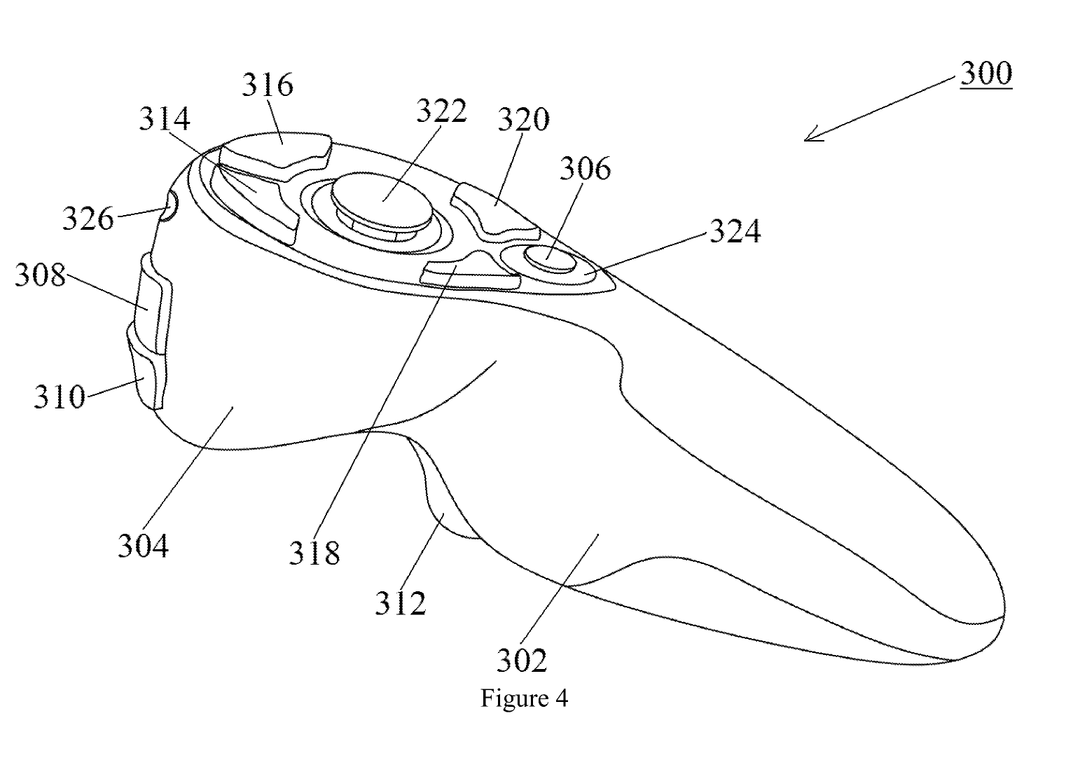

FIG. 4 illustrates the perspective diagrams of the integrated wired/wireless virtual unit control apparatus according to the embodiments of the present invention. The housing of the integrated wired/wireless virtual unit control apparatus 300 essentially comprises a grip portion 302 and a main portion 304, and they can be formed as an integrated component or as combinative components. The integrated wired/wireless virtual unit control apparatus 300 comprises a plurality of operational component and output component. The plurality of operational components comprise a power key 306, to provide function of turning on/off the power of the virtual unit control apparatus 300; a first key 308, a second key 310 formed at the bottom of the front of main portion 304, a third key 312 formed at the bottom of the front of grip portion 302, a forth key 314, a fifth key 316, a sixth key 318, and a seventh key 320 formed around the upper surface of main portion 304 for providing different functions; a D-pad, a joystick, a tracking ball, a touch panel, a keyboard, of the combinations thereof is coupled to the MCU 112 for inputting control signal by the user. However, it is implemented as a joystick 322 in FIG. 4.

In FIG. 4, the integrated wired/wireless virtual unit control apparatus 300 further comprises a signal light 324 and a laser diode emitting device 326. The signal light 324 can be implemented as a light-Emitting Diode (LED) coupling to the MCU 112 for providing reminder functions. For example, the signal light 324 can be cooperated with the wireless transmission module 116 illustrated in FIG. 2. When the user controls the television via the wireless transmission module 116, the signal light 324 may emitting light with the corresponding signal transmission and remind the user the condition under processing. Further, the signal light 324 can also be cooperated with other signal modules, such as finger control signal module 124 and other modules or components mentioned above. When cooperating with various signals, the signal light 324 may emit different colors for better discrimination, for example, press the power key 306 and last for eight seconds, the integrated wired/wireless virtual unit control apparatus 300 turns into automated signal detecting and pairing mode, the signal light 324 flashes with blue and orange LEDs. The laser diode emitting device 326 can be implemented as a laser pointer, project a laser beam when turned on, and it provides the function of a pointer. The wavelengths of laser beam projected by the laser diode emitting device 326 are better from 380 to 750 nm. The laser diode emitting device 326 couple to a button as switch, the switch mode comprises: press and hold the key to turn on and release to turn off, press once to turn on and press again to turn off, or other mode of using the key to turn on and off. It should be noted that for purpose of brevity, it only shows seven keys 308, 310, 312, 314, 316, 318 and 320 in illustrations. However, any other number of keys may be formed in a similar way to provide more variation in other embodiments of the present invention. The first key 308 can be implemented as, for example, the middle button of a mouse, the second key 310 can be implemented as the left button of a mouse, the third key 312 can be implemented as the right button of a mouse, provides user ability to control any function implemented to a mouse, such as single click, double click, drag, circle, open the menu or any other functions. For example, the fourth key 314 can be implemented as the black screen function of PowerPoint, the fifth key 316 can be implemented as switch of laser diode emitting device, the sixth key 318 can be implemented as “page up” key on keyboard, and the seventh key 320 can be implemented as “page down” key on keyboard, provides user to control every kind of direction changing functions in application device, for example, direction control key, for controlling the direction of, for example, cursor, visual angle, etc. Each of the keys mentioned above is coupled to the MCU 112 and the related component in FIG. 2 for providing the above-mentioned functionalities.

In the embodiments of the present invention, the housing and the control keys of the integrated wired/wireless virtual unit control apparatus 300 are designed for ease of moving the cursor or gaming games by the user. For example, use the joystick 322 alone to control the movement of cursor in computer, the cursor in computer moves in default speed, and blue and orange LEDs of the signal light 324 light up together; if press the first key 308, the second key 310, the third key 312, and the sixth key 318, then slide the joystick 322 to the left, the speed of movement of the cursor in computer switch to low speed, and the signal light 324 light up in orange, when user controls the movement of the cursor in computer with joystick 322, the cursor in computer moves at low speed; if press the first key 308, the second key 310, the third key 312, and the sixth key 318, then slide the joystick 322 to the right, the speed of movement of the cursor in computer switch to high speed, and the signal light 324 light up in blue, when user controls the movement os the cursor in computer with joystick 322, the cursor in computer moves at high speed. The combinations of keys for switching the cursor movement speed mentioned above are for better understanding and describing examples of the present invention, it should be appreciated that the control of switching cursor movement speed can be any combination of one or more than one key with joystick.

With collocating the joystick and other key(s), the speed of movement of the cursor in computer, for example, is adjustable instantly when the cursor is moving. For example, when pressing the first key and control the joystick at the same time, to change the default movement speed of the cursor in computer to the second movement speed, the second speed is different from the default speed, to fit the needs when users using the integrated wired/wireless virtual unit control apparatus 300. The combination of keys and joystick for switching the cursor movement speed instantly are used for better understanding and describing examples of the present invention, it should be appreciated that the control of switching cursor movement speed can be any combination of one or more than one key with joystick. However, in other embodiment of present invention, different functions can be designated to all the keys by the user, and adding other units not shown in the figure. For example, in another embodiment of the present invention, there may be a key defined for adjusting speed of the cursor. The defined key for adjusting speed of the cursor can be used with signal light 324 for showing the current movement speed of the cursor. Press the defined key once, the movement speed of the cursor in computer is default speed, blue and orange LEDs of the signal light 324 light up together, if press the defined key twice, the movement speed of the cursor in computer switches to low speed, and the signal light 324 light up in orange; if press the defined key thrice, the movement speed of the cursor in computer switch to high speed, and the signal light 324 light up in blue. The key defined for adjusting speed of the cursor is for giving an example, it can be any combination of one or more than one key with joystick.

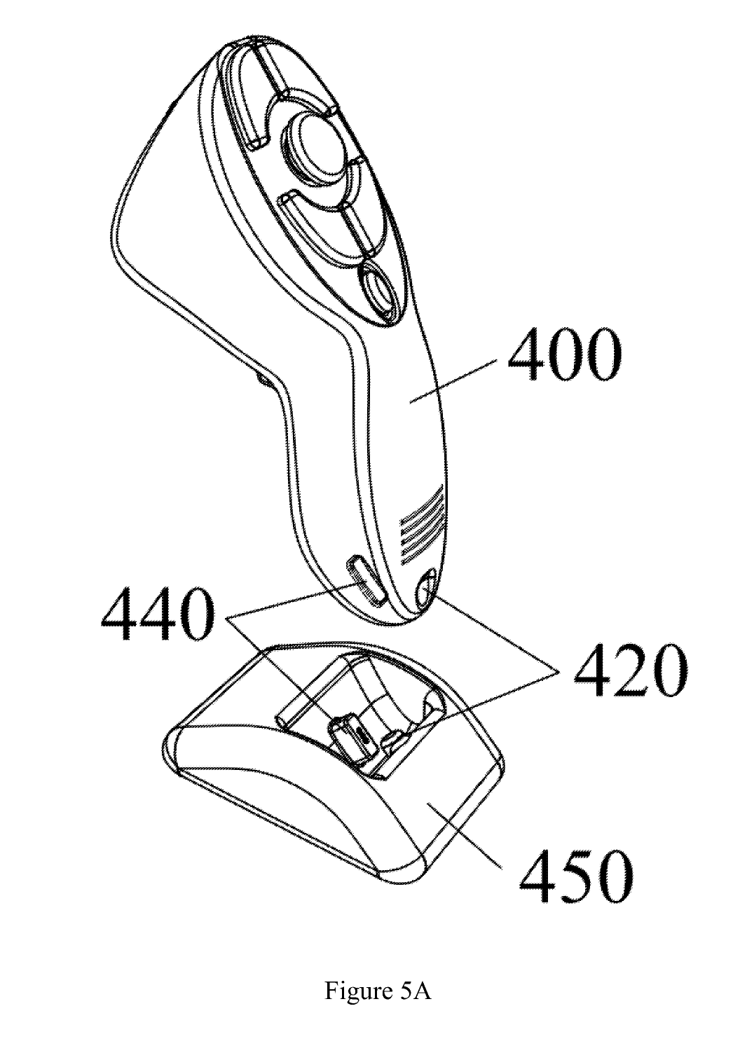

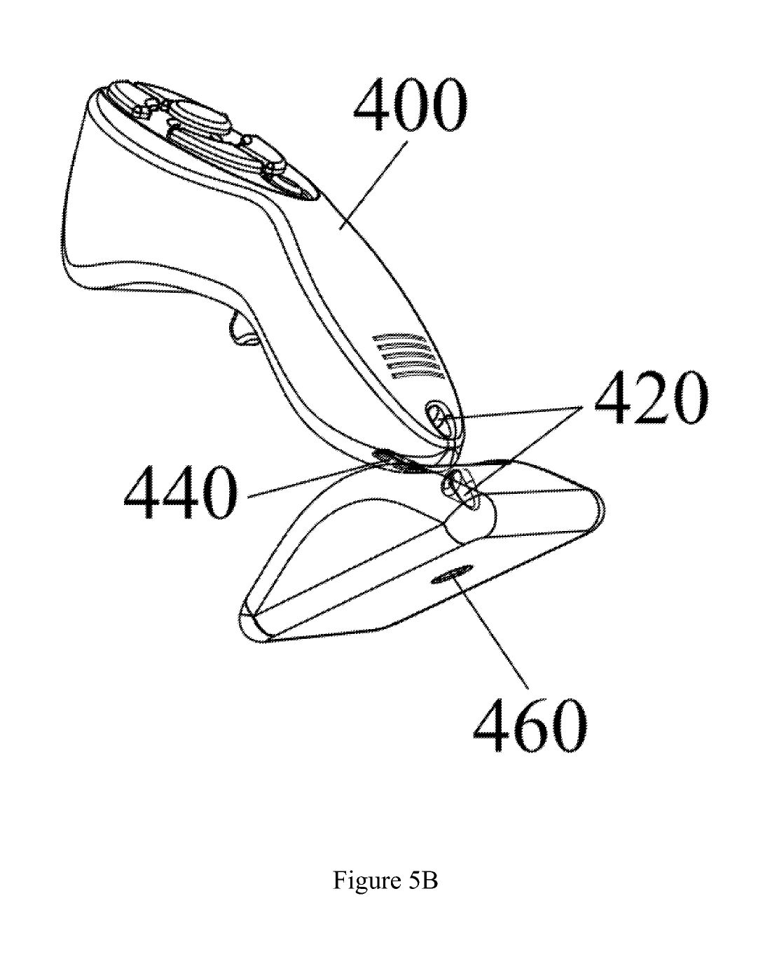

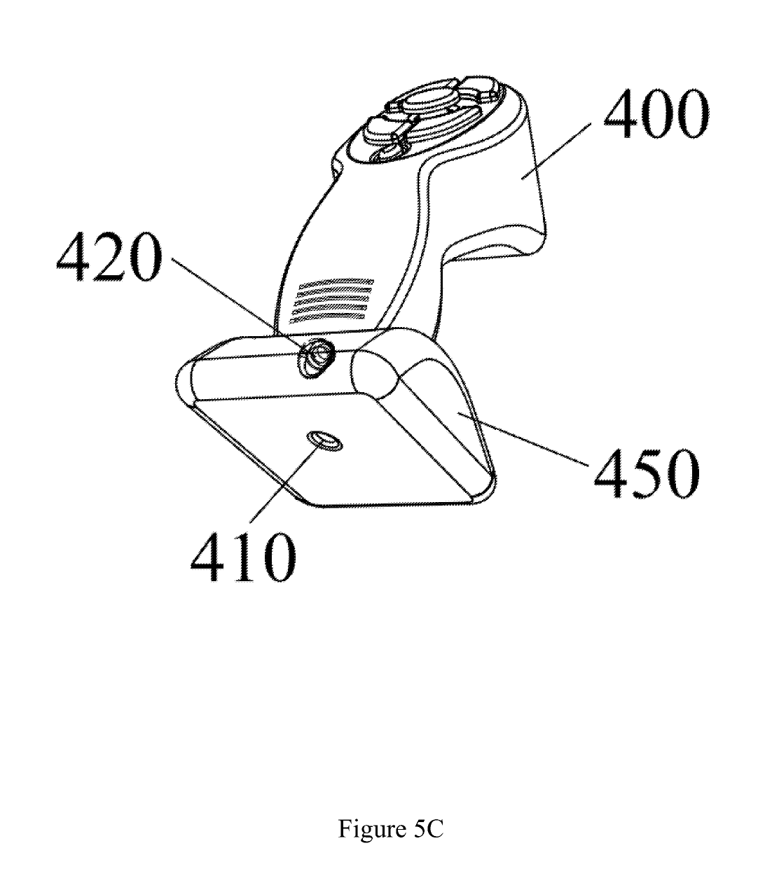

Please referring to FIG. 2A and FIG. 5A, FIG. 2A illustrates another functional block diagram of the integrated wired/wireless virtual unit control apparatus according to the embodiments of the present invention, and FIG. 5A illustrates the perspective diagrams of the integrated wired/wireless virtual unit control apparatus according to the embodiments of the present invention. In FIG. 2A and FIG. 5A, the integrated wired/wireless virtual unit control apparatus 100, 400 further comprises a removable base 450, for the integrated wired/wireless virtual unit control apparatus 100, 400 setting on the removable base 450. There is at least one mounting 420 formed between the integrated wired/wireless virtual unit control apparatus 400 and the removable base 450 to solid mounting the integrated wired/wireless virtual unit control apparatus 100, 400 and the removable base 450. The at least one mounting 420 further comprises, but not limited to, bolt, pin, slide, screw, frictional plane, spring, and the combination thereof. There could be at least one electrical coupling unit 440 formed between the integrated wired/wireless virtual unit control apparatus 100, 400 and the removable base 450, for transporting electrical signals between the integrated wired/wireless virtual unit control apparatus 100, 400 and the removable base 450. In one embodiment, the electrical coupling unit 440 and the mounting 420 is formed as an integrated component.

Please referring to FIG. 2A and FIG. 5B, FIG. 2A illustrates another functional block diagram of the integrated wired/wireless virtual unit control apparatus according to the embodiments of the present invention; FIG. 5B illustrates another embodiment of the integrated wired/wireless virtual unit control apparatus of the present invention. In FIG. 2A and FIG. 5B, the integrated wired/wireless virtual unit control apparatus 100, 400 further comprises removable base 450 comprising a sensing module 460 for sensing movement of the removable base 450 and generating a movement signal. The movement signal generated by the sensing module 460 is transported to the MCU 112 of the integrated wired/wireless virtual unit control apparatus 100, 400 through the electrical coupling unit 440. The sensing module 460 comprises an optical module or a tracking ball module.

FIG. 5C illustrates the other embodiment of the integrated wired/wireless virtual unit control apparatus of present invention. The integrated wired/wireless virtual unit control apparatus 400 further comprises a sensing module 410 formed on the housing of the integrated wired/wireless virtual unit control apparatus and coupled to said MCU, for sensing movement of said integrated wired/wireless virtual unit control apparatus 400 when setting on said removable base 450, generating a movement signal, and transporting said movement signal to said MCU. The sensing module 410 comprises optical sensing module or tracking ball module.

For providing thoroughly understanding of the present invention, there are some terminologies used in the foregoing description. However, it should be appreciated that certain specific details are not necessary in implementing the present invention. Therefore, each of the specific embodiments of the present invention is for purpose of description but not for purpose of limiting the present invention to a specific detail. For example, the layout of the functional block diagram may be modified under the teaching of the present invention, and the illustrated or not illustrated components may be replaced by components with similar functionalities or equivalents. Some components are not necessarily required when implementing the present invention. It should be obvious that some modifications or variations may be made under the teaching or suggestion of the embodiments of the present invention for better accommodation with different environments or conditions, but they should be included in the present invention. Therefore, the scope of the present invention should be defined by the following claims and the equivalents.

What is claimed is:

1. An integrated wired/wireless virtual unit control apparatus comprising:
at least one micro-controller unit (MCU), to maintain the operations of said integrated wired/wireless virtual unit control apparatus;
at least one finger control signal module coupling to said at least one MCU, to generate movement signals caused by finger controlling of said user; and
at least one signal transmission module coupling to said at least one MCU, to receive said movement signals from said at least one finger control module and transmit said movement signals to at least one appliance for controlling positions of a cursor on said at least one appliance according to said movement signals from said at least one appliance;
wherein said at least one signal transmission module comprises wired transmission module, wireless transmission module, or a combination thereof.

2. The integrated wired/wireless virtual unit control apparatus as claim 1, further comprising at least one gyro signal module coupling to said at least one MCU, to generate movement signals caused by movements of said integrated wired/wireless virtual unit control apparatus controlled by a user; and said at least one signal transmission module can receive said movement signals from said at least one gyro signal module and transmit said movement signals to at least one appliance for controlling positions of a cursor on said at least one appliance according to said movement signals from said at least one gyro signal module.

3. The integrated wired/wireless virtual unit control apparatus as claim 2, further comprising at least one television remote controller chip coupling to said at least one MCU, to copy codes of function keys from at least one television remote controller for providing function of providing a backup television remote controller; wherein said function keys comprising channel selecting, volume adjusting, power turning on and off or combinations thereof; wherein said at least one television remote controller chip and said at least one MCU are components integrated in one chip or several independent chips.

4. The integrated wired/wireless virtual unit control apparatus as claim 3, further comprising at least one transmitter module coupling to said at least one television remoter controller chip for transmitting television controlling signal; and further comprising at least one learning module coupling to said MCU for providing function of learning said codes of function keys; and further comprising at least one memory chip coupling to said MCU for providing function of memorization.

5. The integrated wired/wireless virtual unit control apparatus as claim 2, further comprising at least one signal selection module coupling to said at least one MCU, said at least one gyro signal module, and said at least one finger control signal module; said at least one signal selection module comprises at least one signal selection switch for providing function of selecting said movement signals from said at least one gyro signal module or said at least one finger control signal module by said user.

6. The integrated wired/wireless virtual unit control apparatus as claim 2, further comprising at least one appliance switching module coupling to said at least one MCU for switching between a plurality of hardware, operational systems, or combinations thereof of said at least one appliance, and wherein said at least one appliance comprises personal computer (PC), notebook, netbook, mobile phone, electronic dictionary, personal digital assistant (PDA), global positioning system (GPS), digital mobile audio device, mobile gaming device, or combinations thereof.

7. The integrated wired/wireless virtual unit control apparatus as claim 5, further comprising at least one digital-to-analog converter (DAC), analog-to-digital converter (ADC), or combinations thereof coupling to said at least one MCU and said at least one finger control signal module or said at least one signal selection module for receiving said movement signals from said at least one finger control signal module or said at least one signal selection module and processing digital-to-analog conversion, analog-to-digital conversion, or combinations thereof.

8. The integrated wired/wireless virtual unit control apparatus as claim 2, further comprising at least one battery set coupling to said wired transmission module for receiving electric power from said wired transmission module and then storing; at least one DC/DC converter coupling to said at least one battery set and said at least one MCU for receiving said electric power from said at least one battery set, transferring said electric power to electric power with predetermined voltage, and providing said electric power with predetermined voltage to said at least one MCU; and at least one low drop-out regulator (LDO regulator) coupling to said at least one battery set for receiving said electric power from said at least one battery set, transferring said electric power to electric power with regulation, and providing said electric power with regulation to said wireless transmission module.

9. The wired/wireless virtual unit control apparatus as claim 2, further comprising at least one wireless transmission controller connected internal or external to said at least one appliance, said at least one wireless transmission controller is coupled to at least one controlling unit of said at least one appliance for transmitting with said wireless transmission module of said integrated wired/wireless virtual unit control apparatus; and further comprising at least one left key, right key, roller key, function key, or combinations thereof coupling to said at least one MCU for providing functions of clicking, double-clicking, turning page, pressing and dragging, setting and using function key, or combinations thereof; wherein functions of said function key comprises closing the present program window used by said user; and further comprising at least one reset switch coupling to said at least one MCU for resetting connection and transmission of data between said integrated wired/wireless virtual unit control apparatus and said at least one appliance; and further comprising at least one auto-detecting module coupling to said at least one MCU for automatically detecting appliance matching codes of said integrated wired/wireless virtual unit control apparatus and appliance can be controlled by said integrated wired/wireless virtual unit control apparatus.

10. The integrated wired/wireless virtual unit control apparatus as claim 1, wherein said at least one finger control signal module further comprises directional pad (D-pad), joystick, tracking ball, touch panel, keyboard, or combinations thereof; said at least one finger control signal module better comprises at least one potentiometer coupling to said at least one MCU for providing electric potentials to said at least one MCU according to inputs from said at least one finger control signal module; it is much better further comprising at least one analog-to-digital converter (ADC), digital-to-analog converter (DAC), or combinations thereof between said at least one potentiometer and said at least one MCU.

11. The integrated wired/wireless virtual unit control apparatus as claim 2, wherein said at least one gyro signal module further comprises at least one acceleration sensor coupling said at least one MCU for providing acceleration values to said at least one MCU; wherein said at least one MCU and said at least one appliance further comprise at least one corresponding hand-writing software for generating corresponding letters or symbols according to said movement signals from said at least one gyro signal module or said at least one finger control signal module; and at least one fast deleting key coupling to said at least one MCU for providing functions of fast deleting said letters or symbols that are written mistakenly.

12. The integrated wired/wireless virtual unit control apparatus as claim 1, wherein said wireless transmission module further comprises modules of Bluetooth, infra-red, radio frequency, zigbee, or combinations thereof; wherein said wired transmission module comprises USB, PS/2, or combinations thereof.

13. The integrated wired/wireless virtual unit control apparatus as claim 1, further comprising a virtual unit control apparatus housing for containing and combining components; at least one grip portion for griping by said user; and at least one display screen set on surface of said integrated wired/wireless virtual unit control apparatus coupling to said at least one MCU for providing information displaying; wherein said information comprising item menu of said at least one appliance, item chosen by said user, remaining electric power of said at least one battery set, or combinations thereof.

14. The integrated wired/wireless virtual unit control apparatus of claim 1, wherein said at least one MCU further comprises functions of power management, and said functions of power management comprises automatically turning on, turning off, or combinations thereof on predetermined time.

15. The integrated wired/wireless virtual unit control apparatus of claim 1, further comprising at least one laser diode emitting device coupling to at least one MCU and/or at least one finger control signal module, to project a light spot to provide the function of a pointer; wherein said laser spot projected by said laser diode emitting device better comprises visible laser beams that wavelengths are between 380 to 750 nm.

16. The integrated wired/wireless virtual unit control apparatus of claim 1, further comprising a removable base, for said integrated wired/wireless virtual unit control apparatus setting on said removable base; wherein there is at least one mounting formed between said integrated wired/wireless virtual unit control apparatus and said removable base to solid mounting thereof; wherein said at least one mounting comprises bolt, pin, slide, screw, frictional plane, spring, and the combination thereof.

17. The integrated wired/wireless virtual unit control apparatus of claim 16, wherein said removable base comprises a sensing module for sensing movement of said removable base, and generating a movement signal; and there is at least one electrical coupling unit formed between said integrated wired/wireless virtual unit control apparatus and said removable base, for transporting said movement signal generated by said sensing module to said MCU of said integrated wired/wireless virtual unit control apparatus; wherein said sensing module better comprises an optical module or a tracking ball module; wherein said at least one electrical coupling unit and said at least one mounting are better formed as an integrated component.

18. The integrated wired/wireless virtual unit control apparatus of claim 16, wherein said integrated wired/wireless virtual unit control apparatus further comprises a sensing module formed on said virtual unit control apparatus housing and coupled to said MCU, for sensing movement of said integrated wired/wireless virtual unit control apparatus when said integrated wired/wireless virtual unit control apparatus set on said removable base, generating a movement signal, and transporting said movement signal to said MCU.

19. A method of using said integrated wired/wireless virtual unit control apparatus of claim 1 comprising:
controlling said finger control signal module to generate said movement signals to change the speed of movement of cursor in said at least one appliance.

20. The method of claim 19, further comprising:
pressing at least one button and controlling a direction controlling interface at the same time, to change the default movement speed of said cursor in said appliance to the second movement speed;
controlling said the direction controlling interface, said cursor moves in said the second movement speed;
wherein said direction controlling interface comprises directional pad, joystick, tracking ball, touch panel, keyboard or the combination thereof.

21. The method of claim 19, further comprising:
pressing the first button and control said direction controlling interface at the same time, such that said cursor moves in said the second movement speed;
releasing said the first button and controlling said direction controlling interface, such that said cursor moves in said the default movement speed;
wherein said direction controlling interface comprises directional pad, joystick, tracking ball, touch panel, keyboard or the combination thereof.
